(19) United States
(12) Patent Application Publication
(10) Pub. No.: US 2025/0140263 A1
(43) Pub. Date: May 1, 2025

(54) DETECTING SYNTHETIC SPEECH USING A MODEL ADAPTED WITH INDIVIDUAL SPEAKER AUDIO DATA

(71) Applicant: SRI International, Menlo Park, CA (US)

(72) Inventors: Diego Castan Lavilla, Dobbs Ferry, NY (US); MD Hafizur Rahman, Santa Clara, CA (US); Mitchell Leigh McLaren, Everton Park (AU); Christopher L. Cobo-Kroenke, San Francisco, CA (US); Aaron Lawson, Sutter Creek, CA (US)

(21) Appl. No.: 18/730,061

(22) PCT Filed: Dec. 23, 2022
(86) PCT No.: PCT/US2022/082357

§ 371 Date: Jul. 18, 2024

Related U.S. Application Data
(60) Provisional application No. 63/306,444, filed on Feb. 3, 2022.

(51) Int. Cl. G10L 17/18; G06N 3/047; G10L 17/04

(52) U.S. Cl. CPC G10L 17/18; G06N 3/047; G10L 17/04

(57) ABSTRACT

In some examples, a computing system includes a storage device configured to store a front-end neural network and a back-end model; and processing circuitry. The processing circuitry is configured to: receive a test audio data sample; process, by executing the front-end neural network, the test audio data sample to extract one or more embeddings from the front-end neural network; process, by executing the back-end model, the one or more embeddings to determine a likelihood that indicates whether the test audio data sample represents speech by a particular human; and output an indication as to whether the test audio data sample represents genuine speech by the particular human.

This application claims the benefit of U.S. Provisional Patent Application No. 63/306,444, filed Feb. 3, 2022, the entire contents of which is incorporated herein by reference.

### GOVERNMENT RIGHTS

This invention was made with Government support under contract no. DE-NA0003525 awarded by the National Technology and Engineering Solutions of Sandia, LLC under contract by the Department of Energy. The Government has certain rights in this invention.

### TECHNICAL FIELD

This disclosure is related to machine learning systems, and more specifically to executing a machine learning model to identify synthetic media data.

### BACKGROUND

A system may execute a machine learning model to determine a likelihood that an audio sample includes genuine speech. The system may train the machine learning model using training data including a plurality of training datasets. For example, to train a supervised learning (SL) model, the system may analyze the plurality of training datasets to generate an inferred function. The system may execute the inferred function in order to evaluate the likelihood that a new audio sample includes genuine speech.

### SUMMARY

In general, the disclosure describes one or more techniques for determining whether a media sample includes genuine speech from a human speaker. Machine learning models may, in some cases, generate synthetic media that imitates the visual likeness, mannerisms, and/or voice of a human individual. These synthetic media are often used for malevolent purposes such as perpetrating frauds, falsifying events, impersonating public figures, and spreading online misinformation and disinformation. “Deepfakes” are a type of synthetic media in which a person in a media sample is replaced with another person's likeness. Several factors have increased the threat of deepfakes in recent years, including advances in machine learning technology and the increased availability of media data on the internet. This means that deepfakes and other types of synthetic media have become more difficult to detect as being synthetic. Although machine learning models can generate synthetic media, machine learning models can also be trained to identify synthetic media, including deepfakes. Techniques described herein that improve the ability of machine learning models to identify synthetic media are beneficial to improve the ability of users and systems to detect fraud, false events, misinformation, and disinformation.

In some examples, a computing system may execute a front-end neural network. The front-end neural network may, in some examples, comprise a residual neural network (ResNet) or another kind of neural network that is configured to receive media samples as input and generate an output. ResNets are artificial neural networks (ANNs) that comprise a set of layers. These layers process the input data to generate the output. The computing system may train the layers of the front-end neural network using a set of general training data comprising a set of genuine media data samples and a set of synthetic media data samples. During training, the computing system configures the layers of front-end neural network based on with one or more patterns associated with the genuine media data samples and one or more patterns associated with the synthetic media data samples. In some examples, to configure the layers with one or more patterns, the computing system may configure the front-end neural network with a set of embeddings. When the neural network is trained, the layers of the neural network may process an incoming media sample to extract one or more embeddings from the front-end neural network.

The computing system may execute a back-end model to process the one or more embeddings extracted from the front-end neural network. In some examples, the back-end model may transform the one or more embeddings to generate an output. The back-end model may use linear analysis techniques such as linear discriminant analysis (LDA) and probabilistic LDA (PLDA) to transform the one or more embeddings. The computing system may adapt the back-end model using individual speaker data. In some examples, the individual speaker data may include a set of media samples known to be associated with a particular human. When the back-end model is adapted using the individual speaker data, the back-end model may determine whether an incoming data sample corresponds to the particular human.

The techniques may provide one or more advantages that realize at least one practical application. For example, by training the front-end neural network using general training data including audio data samples known to include genuine speech and audio data samples known to include synthetic speech, and by adapting the back-end model using individual speaker data known to include speech from a particular human, the computing system may improve a system's ability to detect deepfakes targeting a specific individual as compared with systems that do not adapt a back-end model using individual speaker data. Since deepfakes can leverage large amounts of media data featuring a public figure, for instance, a system that trains a model to detect deepfakes using the large amount of available media data may more accurately detect a deepfake targeting the public figure as compared with systems that do not train models using the available media data featuring the public figure. Furthermore, by implementing a two-step process of executing a front-end neural network trained to extract one or more embeddings, and executing a back-end neural network trained using the one or more embeddings to determine whether the media sample represents speech by a particular human, the computing system described herein may improve an accuracy of detecting deepfakes as compared with systems that do not use a two-step process.

In some examples, a computing system includes a storage device configured to store a front-end neural network and a back-end model; and processing circuitry. The processing circuitry is configured to: receive a test audio data sample; process, by executing the front-end neural network, the test audio data sample to extract one or more embeddings from the front-end neural network; process, by executing the back-end model, the one or more embeddings to determine a likelihood that indicates whether the test audio data sample represents speech by a particular human; and output an indication as to whether the test audio data sample represents genuine speech by the particular human.

In some examples, a method comprises receiving, by processing circuitry having access to a storage device, a test audio data sample, wherein the storage device is configured to store a front-end neural network and a back-end model; processing, by executing the front-end neural network by the processing circuitry, the test audio data sample to extract one or more embeddings from the front-end neural network; processing, by executing the back-end model by the processing circuitry, the one or more embeddings to determine a likelihood that indicates whether the test audio data sample represents speech by a particular human; and outputting, by the processing circuitry, an indication as to whether the test audio data sample represents genuine speech by the particular human.

In some examples, a computer-readable medium comprising instructions that, when executed by a processor, cause the processor to: receive a test audio data sample, wherein the processor is in communication with a storage device is configured to store a front-end neural network and a back-end model; process, by executing the front-end neural network, the test audio data sample to extract one or more embeddings from the front-end neural network; process, by executing the back-end model, the one or more embeddings to determine a likelihood that indicates whether the test audio data sample represents speech by a particular human; and output an indication as to whether the test audio data sample represents genuine speech by the particular human.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating a system for training one or more models to process media data, in accordance with one or more techniques of this disclosure.

FIG. 2 is a block diagram illustrating a system including an example computing system 202 that implements a machine learning system to determine a likelihood that one or more test audio data samples include genuine speech from a particular human, in accordance with one or more techniques of this disclosure.

FIG. 3 is a conceptual diagram illustrating a system for processing a test audio data sample to generate an output, in accordance with one or more techniques of this disclosure.

FIG. 4 is a conceptual diagram illustrating a graph of one or more outputs from a system configured to determine a likelihood that a test audio data sample includes genuine speech from a particular human, in accordance with one or more techniques of this disclosure.

FIG. 5 is a flow diagram illustrating an example technique for determining a likelihood that a test audio data sample includes genuine speech from a particular human, in accordance with one or more techniques of this disclosure.

Like reference characters refer to like elements throughout the figures and description.

### DETAILED DESCRIPTION

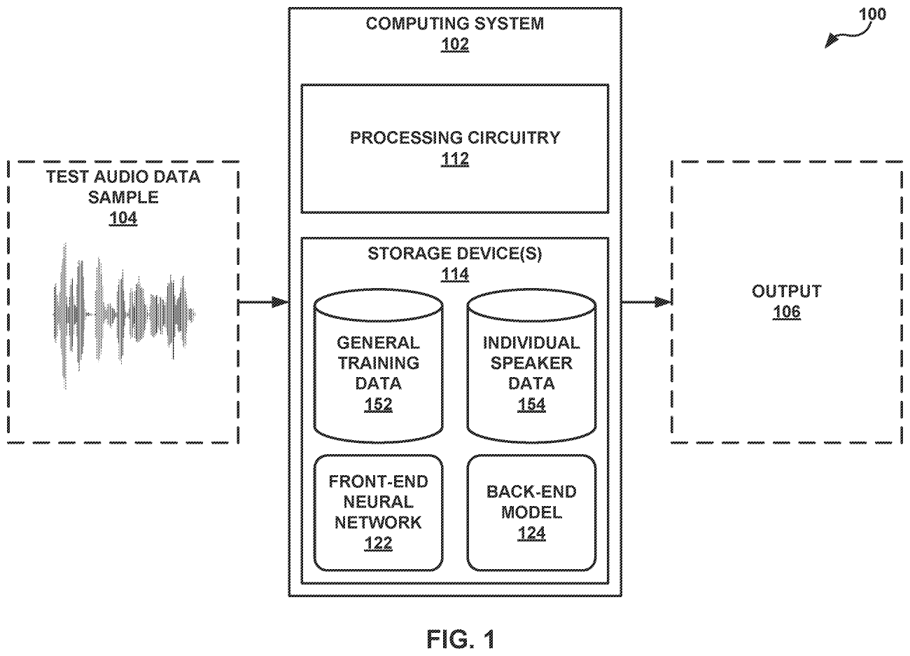

FIG. 1 is a block diagram illustrating a system 100 for training one or more models to process media data, in accordance with one or more techniques of this disclosure. As seen in FIG. 1, system 100 includes a computing system 102 configured to receive a test audio data sample 104 and generate an output 106. Computing system 102 includes processing circuitry 112 and one or more storage device(s) 114 (hereinafter, “storage device(s) 114”). Storage device(s) 114 are configured to store a front-end neural network 122, a back-end model 124, general training data 152, and individual speaker data 154. Although computing system 102 system 100 is shown in FIG. 1 as processing an audio sample, computing system 102 is not limited to processing audio data. Computing system 102 may, in some cases, be configured to process video data, print media data, or another kind of media data.

In some examples, computing system 102 may be configured to process test audio data sample 104 to generate an output 106 that indicates whether test audio data sample 104 reflects genuine speech from a particular human, i.e., the so-called “speaker-of-interest”. Deepfakes sometimes include synthetic audio that mimics the speech of a particular human speaker, even when the audio data of the deepfake is not genuine and was never spoken by the particular human speaker. Deepfakes can be especially effective in impersonating public figures, because there is a large volume of genuine media data featuring public figures available on the internet. For example, thousands of hours of genuine audio data featuring a world-renowned podcaster may be available on the internet. This large amount of data may be used to train a deepfake that impersonates the speech of the world-renowned podcaster, and this deepfake may sound “more genuine” to the human ear as compared with a deepfake impersonating a less high-profile individual who does not have as much genuine media data available on the internet. Computing system 102 may, in some cases, adapt one or more models using media data specific to a particular human in order to improve the system's ability to detect deepfakes targeting individuals.

In some examples, the term “genuine speech” may be referred to herein as being speech present in an audio sample that was actually spoken by any living human being and recorded to create the audio sample. In some examples, the term “speech by a particular human” may be referred to herein as speech present in an audio sample that was actually spoken by the particular human and recorded to create the audio sample, where the speech was not spoken by any other living human beings other than the particular human. In some examples, the term “synthetic audio data” may be referred to herein as audio data present in an audio sample that is generated by a computer to reflect sound that imitates human speech, but does not reflect actual speech that was spoken by a living human being and recorded to create the audio sample.

Test audio data sample 104 may include audio data. In some examples, the audio data may include a sequence of speech. Additionally, or alternatively, the audio data may include one or more background components such as noise, codec, reverb, and music. In some examples, it may be unknown whether the test audio data sample 104 represents a recording of genuine speech from a particular human speaker, or whether the test audio data sample 104 represents synthetic speech that is generated to imitate speech of that particular human speaker. Computing system 102 may process test audio data sample 104 to generate an output 106 that indicates whether test audio data sample 104 includes genuine speech from a particular human speaker or synthetic speech generated to imitate human speech.

Computing system 102 may include processing circuitry 112. Processing circuitry 112 may include, for example, one or more microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, processing circuitry 112 of computing system 102 may include any suitable structure, whether in hardware, software, firmware, or any combination thereof, to perform the functions ascribed herein to system 100.

Computing system 102 includes one or more storage device(s) 114 in communication with the processing circuitry 112 of computing system 102. In some examples, storage device(s) 114 include computer-readable instructions that, when executed by the processing circuitry 112, cause system 102 to perform various functions attributed to system 100 herein. Storage devices 114 may include any volatile, non-volatile, magnetic, optical, or electrical media, such as a random-access memory (RAM), read-only memory (ROM), non-volatile RAM (NVRAM), electrically erasable programmable ROM (EEPROM), flash memory, or any other digital media capable of storing information.

Computing system 102 may comprise any suitable computing system having one or more computing devices, such as desktop computers, laptop computers, gaming consoles, smart televisions, handheld devices, tablets, mobile telephones, smartphones, etc. In some examples, at least a portion of computing system 102 is distributed across a cloud computing system, a data center, and/or across a network, such as the Internet, another public or private communications network, for instance, broadband, cellular, Wi-Fi, and/or other types of communication networks, for transmitting data between computing systems, servers, and computing devices. One or more components of computing system 102 (e.g., processing circuitry 112, storage devices 114, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 112 of computing system 102 may implement functionality and/or execute instructions associated with computing system 102. Computing system 102 may use processing circuitry 112 to perform operations in accordance with one or more aspects of the present disclosure using software, hardware, firmware, or a mixture of hardware, software, and firmware residing in and/or executing at computing system 102, and may be distributed among one or more devices. The one or more storage device(s) 114 may represent or be distributed among one or more devices.

Storage device(s) 114 are configured to store a front-end neural network 122. In some examples, front-end neural network 122 comprises a residual neural network (ResNet) or another kind of neural network. ResNets are artificial neural networks (ANNs) that comprise a set of layers. In some examples, each layer of the set of layers may include a set of artificial neurons. Artificial neurons of front-end neural network 122 may connect with other artificial neurons to the front-end neural network 122 such that the artificial neurons can transmit signals among each other. Data input to an ANN may traverse the ANN from an input layer to an output layer, and in some examples, traverse the ANN more than one time before the model generates an output. In some examples, the output from front-end neural network 122 indicates whether the test audio data sample 104 includes genuine speech from any human speaker, or whether the test audio data sample 104 includes synthetic speech generated to impersonate a human speaker.

In some examples, the layer of the front-end neural network 122 that receives test audio data sample 104 is known as the “input layer” and the layer of the front-end neural network 122 that generates an output is known as the “output layer.” One or more “hidden layers” may be located between the input layer and the output layer. Adjacent layers within the front-end neural network 122 may be joined by one or more connections. In some examples, every artificial neuron of one layer may be connected to every artificial neuron of an adjacent layer. In some examples, every artificial neuron of one layer may be connected to a single artificial neuron of an adjacent layer. In some examples (e.g., in the example of a ResNet), one or more artificial neurons of a first layer may be connected to one or more artificial neurons of a second layer that is not adjacent to the first layer. That is, connections of some ResNets may “skip” one or more layers. During training, each connection between artificial neurons within front-end neural network 122 may be assigned a weight. The weights of the connections between neurons may determine the output generated by front-end neural network 122 based on the data input to front-end neural network 122. Consequently, weights of connections between artificial neurons may determine whether front-end neural network 122 identifies test audio data sample 104 as including genuine or real speech.

Storage device(s) 114 are configured to store a back-end model 124. In some examples, back-end model 124 uses linear analysis techniques such as linear discriminant analysis (LDA) and probabilistic LDA (PLDA) to process the output from the front-end neural network 122. For example, back-end model 124 may process the output from back-end model 124 to determine whether the test audio data sample 104 includes genuine speech from a particular human speaker. This means that computing system 102 may execute front-end neural network 122 generate an output indicating a likelihood that an audio sample includes genuine speech from any human, and computing system 102 may execute back-end model 124 to determine whether the audio sample includes genuine speech from a particular human speaker. By implementing this two-step process of verifying test audio data sample 104 and training on audio data samples that include genuine speech of a particular human speaker, computing system 102 may be better configured to identify deepfakes and, in some cases, to identify deepfakes generated to impersonate the particular human speaker, as compared with systems that only determine whether an audio sample includes speech from any human speaker.

Computing system 102 may be configured to train the front-end neural network 122 using general training data 152. In some examples, general training data 152 may include a set of genuine audio data samples and a set of synthetic audio data samples. In some examples, each genuine audio data sample of the set of genuine audio data samples may include speech that is known to be genuine speech from a human being. The set of genuine audio data samples may include samples from many different human speakers. That is, the set of genuine audio data samples of the general training data 152 might not be individualized to one human subject. Additionally, or alternatively, the set of genuine audio data samples may include samples from a variety of different background environments (e.g., noisy background, quiet background, echoed background). In some examples, each synthetic audio data sample of the set of synthetic audio data samples may include speech that is known to be synthetic speech generated to imitate a human speaker. The set of synthetic audio data samples may include samples generated to imitate many different human speakers. That is, the set of synthetic audio data samples of the general training data 152 might not be common to one human subject. But the set of synthetic audio data samples are each known to include synthetic speech that was generated by a computer and does not reflect a genuine recording of speech from a human being.

Computing system 102 may train the front-end neural network 122 in part by identifying a set of patterns corresponding to the set of genuine audio data samples and identifying a set of patterns corresponding to the set of synthetic audio data samples. The set of patterns corresponding to the set of genuine audio data samples may include patterns common to audio data that represents a recording of genuine speech spoken by any living human being. For example, the set of patterns corresponding to the set of genuine audio data samples may be more prevalent in audio samples including genuine speech as compared with audio samples including synthetic speech. The set of patterns corresponding to the set of synthetic audio data samples may include patterns common to audio data that is generated to imitate human speech. For example, the set of patterns corresponding to the set of synthetic audio data samples may be more prevalent in audio samples including synthetic speech as compared with audio samples including genuine speech. Computing system 102 may train the front-end neural network 122 such that these patterns are reflected in the layers of the front-end neural network 122. That is, when front-end neural network 122 is trained, the layers of front-end neural network 122 may recognize patterns common to audio samples including genuine speech and the layers of front-end neural network 122 may recognize patterns common to audio samples including synthetic speech. The layers of front-end neural network 122 may process test audio data sample 104 based on patterns identified during training to determine whether the test audio data sample 104 includes genuine speech or synthetic speech.

To train the front-end neural network 122 such that patterns are reflected in the layers of the front-end neural network 122, computing system 102 may configure the layers of front-end neural network 122 to include one or more embeddings corresponding to patterns associated with audio samples including genuine speech and one or more embeddings corresponding to patterns associated with audio samples including synthetic speech. Embeddings may include vector representations of discrete variables. For examples, one or more vector representations of an audio sample including genuine speech may include one or more similarities, or patterns, common with vector representations of other audio samples including genuine speech. Additionally, or alternatively, one or more vector representations of an audio sample including synthetic speech may include one or more similarities, or patterns, common with vector representations of other audio samples including synthetic speech and one or more vector representations of an audio sample including synthetic speech may include one or more differences from with vector representations of audio samples including genuine speech. In general, some embeddings may reflect patterns common to audio samples including genuine speech, and some embeddings may reflect patterns common to audio samples including synthetic speech.

Front-end neural network 122 may therefore include deep-learning models, trained to discriminate edited, synthesized and legitimate audio, and used to extract ‘source’ embeddings of test audio data sample 104 for use in a subsequent backend classification process involving back-end model 124. In general, embeddings collect long-term statistics and are therefore useful to discriminate audio produced with different synthesis tools. Moreover, previous experiments have shown that, while embeddings are very good for modeling different speakers or languages, embeddings have significant content about the domain too. Because it is likely that information about the software for generating synthetic audio will also be encoded in the embeddings, such information can be used to detect the presence of synthetic audio.

In some examples, to configure the front-end neural network 122 with the set of patterns prevalent in the set of genuine audio data samples and the set of patterns prevalent in the set of synthetic audio data samples, computing system 102 may set the weights between artificial neurons of front-end neural network 122 to reflect these patterns. In some examples, setting the weights between artificial neurons of front-end neural network 122 may configure front-end neural network 122 with a set of embeddings. Training the front-end neural network 122 may include configuring the front-end neural network 122 with the set of embeddings. By setting the weights between artificial neurons in training the front-end neural network 122, computing system 102 may control the output of front-end neural network 122 to indicate that test audio data sample 104 is likely genuine when test audio data sample 104 exhibits patterns prevalent in genuine audio samples and to indicate that test audio data sample 104 is likely synthetic when test audio data sample 104 exhibits patterns prevalent in synthetic audio samples.

Computing system 102 may adapt the back-end model 124 by identifying a set of patterns corresponding to the set of audio data samples including speech from the particular human speaker. Computing system 102 may adapt the back-end model 124 to identify the set of patterns that are prevalent in genuine speech from the particular human speaker. Back-end model 124 may process the output from front-end neural network 122 to determine whether test audio data sample 104 corresponds to genuine speech from the particular human user. In some examples, the output from front-end neural network 122 may include one or more embeddings extracted from front-end neural network when front-end neural network processes test audio data sample 104. Front-end neural network 122 may process test audio data sample 104 to extract one or more embeddings from a set of embeddings that are configured based on the weights of connections between artificial neurons of front-end neural network 122. Since computing system 102 sets the weights of connections between artificial neurons of front-end neural network 122 based on one or more patterns common to genuine audio data samples and one or more patterns common to synthetic audio data samples, front-end neural network 122 may be configured to identify a prevalence of these patterns in test audio data sample 104 to determine the likelihood.

Although front-end neural network 122 may extract one or more embeddings that indicate whether test audio data sample 104 includes genuine speech from any living human, back-end model 124 may further process the one or more embeddings extracted from front-end neural network 122 to determine whether the test audio data sample 104 includes genuine speech from a particular human. Computing system 102 may be configured to adapt the back-end model 124 using individual speaker data 154. In some examples, individual speaker data 154 may include one or more audio samples including speech from a particular human speaker. The particular human speaker may, in some cases, be a public figure who is associated with a large volume of genuine data available on the internet. Public figures are frequent targets of deepfakes. Consequently, it may be beneficial to adapt a model using media data specific to a particular human speaker to detect deepfakes targeting a particular human being. Each audio sample of individual speaker data 154 may be labeled or otherwise associated with an identifier for the particular human speaker represented in the audio sample. Computing system 102 may receive an identifier for particular human and use the identifier to determine whether test audio data sample 104 includes speech by the identified, particular human.

Linear analysis techniques such as LDA and PLDA may identify a set of features or a linear combination of a set of features to characterize two or more classes of objects. For example, classes of audio data may include a first class of audio data including speech from a particular human speaker and a second class of audio data that does not include speech from the particular human speaker. In some examples, the second class of audio data that does not include speech from the particular human speaker may include audio data featuring synthetic speech generated to imitate the particular human speaker or another human speaker, and audio data featuring genuine speech from a human being other than the particular human speaker. Computing system 102 may adapt back-end model 124 using individual speaker data 154 to identify a linear relationship between audio data including speech from a particular human speaker and audio data that does not include speech from the particular human speaker. By adapting back-end model 124 using audio samples known to include speech from the particular human speaker, computing system 102 may improve the system's ability to detect deepfakes targeting the particular human speaker as compared with systems that do not adapt a model using a set of audio data exclusive to the particular human speaker.

In some examples, computing system 102 may re-train front-end neural network 122 and/or back-end model 124 periodically based on updated general training data 152 and/or individual speaker data 154. For example, general training data 152 and/or individual speaker data 154 may be updated over time based on additional data samples becoming available. Computing system 102 may re-train front-end neural network 122 and/or back-end model 124 using updated training data to ensure that front-end neural network 122 and back-end model 124 reflect the most recent data available to generate deepfakes.

In some examples, computing system 102 may re-adapt back-end model 124 to reflect a different particular human speaker. For example, computing system 102 may adapt back-end model 124 to determine whether test audio data sample 104 includes genuine speech from a first human user using individual speaker data 154 corresponding to the first human user. Computing system 102 may re-adapt back-end model 124 to determine whether test audio data sample 104 includes genuine speech from a second human user using individual speaker data 154 corresponding to the second human user. In some examples, computing system 102 may adapt a set of back-end models each corresponding to a particular human speaker. That is, each back-end model of the set of back-end models may identify whether an audio sample includes speech corresponding to a different particular human speaker.

In some examples, back-end model 124 may adapt with new individual speaker data from a new particular human. In other words, back-end 124 can be updated and new speakers can be enrolled into computing system 102. Therefore, to determine whether an audio sample includes synthetic speech or genuine speech from a new particular human speaker, computing system 102 may incorporate real speech from the new particular human speaker into the individual speaker data 154 in order to adapt back-end model 124 with audio data corresponding to the new individual human speaker. Computing system 102 may more easily and efficiently enroll particular human speakers as compared with systems that do not adapt a back-end model with audio data corresponding to a particular human speaker.

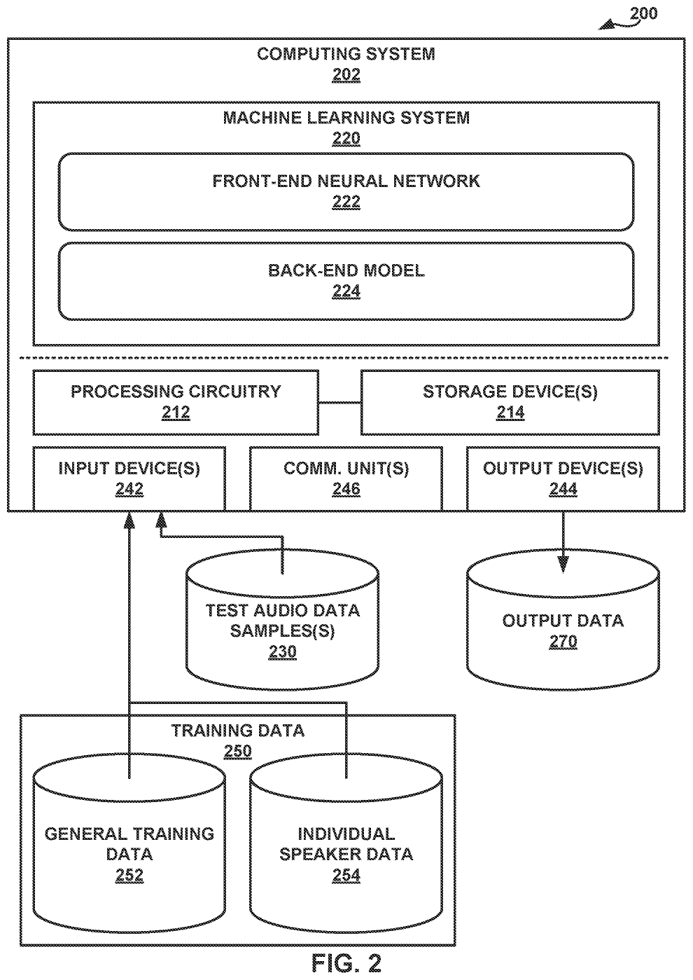

FIG. 2 is a block diagram illustrating a system 200 including an example computing system 202 that implements a machine learning system 220 to determine a likelihood that one or more test audio data samples 230 include genuine speech from a particular human, in accordance with one or more techniques of this disclosure. Computing system 202 may be an example of computing system 102 of FIG. 1; processing circuitry 212 may be an example of processing circuitry 112 of FIG. 1; storage device 214 may be an example of storage device(s) 114 of FIG. 1; front-end neural network 222 may be an example of front-end neural network 122 of FIG. 1; back-end model 224 may be an example of back-end model 124 of FIG. 1; general training data 252 may be an example of general training data 152 of FIG. 1; individual speaker data 254 may be an example of individual speaker data 154 of FIG. 1. As seen in FIG. 2, computing system 202 includes a machine learning system 220 including front-end neural network 222 and back-end model 224. Computing system 202 includes input device(s) 242, communication unit(s) 246, and output device(s) 244.

One or more input devices 242 of computing system 202 may generate, receive, or process input. Such input may include input from storage devices, a keyboard, pointing device, voice responsive system, video camera, biometric detection/response system, button, sensor, mobile device, control pad, microphone, presence-sensitive screen, network, or any other type of device for detecting and/or receiving input from a human or machine.

One or more output devices 244 of computing system 202 may generate, transmit, or process output. Examples of output are tactile, audio, visual, and/or video output. Output devices 244 may include a display, sound card, video graphics adapter card, speaker, presence-sensitive screen, one or more USB interfaces, video and/or audio output interfaces, or any other type of device capable of generating tactile, audio, video, or other output. Output devices 244 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 242 and one or more output devices 244.

One or more communication units 246 of computing system 100 may communicate with devices external to computing system 202 (or among separate computing devices of computing system 202) by transmitting and/or receiving data and may operate, in some respects, as both an input device and an output device. In some examples, communication units 246 may communicate with other devices over a network. In other examples, communication units 246 may send and/or receive radio signals on a radio network such as a cellular radio network. Examples of communication units 246 include a network interface card (e.g. such as an Ethernet card), an optical transceiver, a radio frequency transceiver, a GPS receiver, or any other type of device that can send and/or receive information. Other examples of communication units 246 may include Bluetooth®, GPS, 3G, 4G, and Wi-Fi® radios found in mobile devices as well as Universal Serial Bus (USB) controllers and the like. Computing system 100 may use communication units 246 to communicate with one or more other computing devices or systems. Communication units 246 may be included in a single device or distributed among multiple devices interconnected, for instance, via a computer network coupled to communication units 246. Reference herein to input devices and output devices may refer to communication units 246.

Computing system 202 may be configured to receive data via input device(s) 242. For example, computing system 202 may receive one or more test audio data sample(s) 230 via input device(s) 242. Test audio data sample(s) 230 may, in some examples, include a set of test audio data samples including test audio data sample 104 of FIG. 1. In some examples, one or more test audio data samples of test audio data sample(s) 230 may include speech that is unknown to be genuine or synthetic. In some examples, one or more test audio data samples of test audio data sample(s) 230 may include speech that is known to be either genuine speech from a particular human or synthetic speech generated to imitate the particular human. In any case, test audio data sample(s) 230 may include one or more test audio data samples that are either genuine or synthetic.

Computing system 202 may be configured to receive training data 250 via input device(s) 242. As seen in FIG. 2, training data includes general training data 252 and individual speaker data 254. In some examples, computing system 202 saves training data 250 to storage device. In some examples, training data 250 updates over time, and computing system 202 saves updated training data to storage device 214. For example, computing system 202 may receive additional general training data 252 and/or additional individual speaker data 254. Computing system 202 may augment general training data 252 and/or individual speaker data 254 saved to storage device 214 when computing system 202 receives additional training data via input device(s) 242.

Processing circuitry 212 may train, using general training data 252, front-end neural network 222 of machine learning system 220. In some examples, computing system 202 stores front-end neural network 222 in storage device 214. General training data 252 may include a set of genuine audio data samples and a set of synthetic audio data samples. The set of genuine audio data samples may include speech that is known to be genuine speech from a human speaker and the set of synthetic audio data samples that include speech known to be generated to imitate speech from a human speaker. As used herein, the term “genuine speech” refers to speech that is spoken by a human being and recorded to create an audio sample. As used herein, the term “generated speech” or “synthetic speech” refers to speech in audio samples that is not actually spoken by a human being, but rather is generated by a computer to sound like human speech.

In some examples, the set of synthetic audio data samples of general training data 252 may comprise samples including synthetic speech generated by one or more speech generation models or algorithms. That is, the set of synthetic audio data samples may each by generated by a synthetic speech generation model that is configured to generate deepfakes that system 200 is configured to detect. In some examples, to avoid model over-fitting, general training data 252 may include half of the data generated by each speech generation model of the one or more speech generation models or algorithms. In some examples, to train the front-end neural network 222, computing system 202 may use general training data 252 including the same number of genuine audio data samples and synthetic audio data samples (e.g., 53,000 genuine and 53,000 synthetic speech samples), wherein the synthetic audio data samples may originate from a number of speech generation models (e.g., 32 models).

In some examples, computing system 202 may augment training data 250 with four types of audio degradation: (1) reverb, (2) compression, (3) instrumental music, and (4) noise. Noises may include babble restaurant noises, indoor and outdoor sounds, traffic sounds, mechanical noises, and natural. In some examples, the degradation may include sounds at 5 decibels (dB) signal-to-noise (SNR) ratio. In some examples, computing system 202 may use a frequency masking technique to randomly drop frequency bands during training ranging from f₀ to f₀+f, where f is chosen from a uniform distribution from 0 to a maximum number of masked channels, F.

Processing circuitry 212 may train front-end neural network 222 by identifying one or more patterns associated with the set of genuine audio data samples, identifying one or more patterns associated with the set of synthetic audio data samples, and configuring front-end neural network 222 based on the identified patterns. To configure front-end neural network 222, processing circuitry 212 may set one or more weights of connections between artificial neurons of front-end neural network 222. Configuring the weights of these connections may place the identified patterns into layers of the front-end neural network 222 such that the front-end neural network 222 is able to recognize one or more identified patterns in test audio data sample(s) 230. In some examples, by setting the one or more weights of connections between artificial neurons of front-end neural network 222, the processing circuitry 212 may configure front-end neural network 222 with a set of embeddings.

When front-end neural network 222 is trained using general training data 252, front-end neural network 222 may process each test audio data sample of test audio data sample(s) 230 to extract one or more embeddings from front-end neural network 222. For example, if patterns associated with genuine speech are more prevalent in a test audio data sample than patterns associated with synthetic speech, front-end neural network 222 extract one or more embeddings that indicate the test audio data sample likely includes genuine speech. If patterns associated with synthetic speech are more prevalent in a test audio data sample than patterns associated with generic speech, front-end neural network 222 may extract one or more embeddings that indicate the test audio data sample likely includes synthetic speech.

Processing circuitry 212 may adapt, using individual speaker data 254, back-end model 224 of machine learning system 220. In some examples, computing system 202 stores back-end model 224 in storage device 214. Individual speaker data 254 may include one or more sets of audio data samples each corresponding to a particular human speaker. For example, individual speaker data 254 may include a set of audio data samples that each are known to include genuine speech from a particular human speaker. This means that each audio data sample of the set of audio data samples is known to include genuine speech that is from the same human individual. Processing circuitry 212 may adapt the back-end model 224 of machine learning system 220 using a set of audio data samples that are all known to include genuine speech from the same human individual. When back-end model 224 is trained, back-end model 224 may transform one or more embeddings extracted from front-end neural network 224 to determine whether a test audio data sample includes speech from the particular human associated with a set of audio data samples used to adapt back-end model 224.

Processing circuitry 212 may execute front-end neural network 222 to extract one or more embeddings that indicate a likelihood that a test audio data sample includes genuine speech spoken by a living human being and a likelihood that the test audio data sample includes synthetic speech generated to imitate human speech. In some cases, one or more embeddings extracted from front-end neural network 222 may not indicate a likelihood that the test audio data sample includes genuine speech from a particular human. Processing circuitry 212 may execute back-end model 224 to transform the one or more outputs extracted from the front-end neural network 222. The transformed embeddings may indicate a likelihood that the test audio data sample includes genuine speech from the same particular human speaker associated with the additional speaker data used to adapt back-end model 224. By adapting back-end model 224 using individual speaker data, computing system 202 improves an ability of machine learning system 220 to identify deepfakes targeted at an individual person.

Machine learning system 220 may generate an output that indicates a likelihood that a test audio data sample includes genuine speech from the same particular human speaker associated with training data used to adapt back-end model 224. Computing system 202 may save the output to storage device 214 and/or send the output as output data 270 via output device(s) 244.

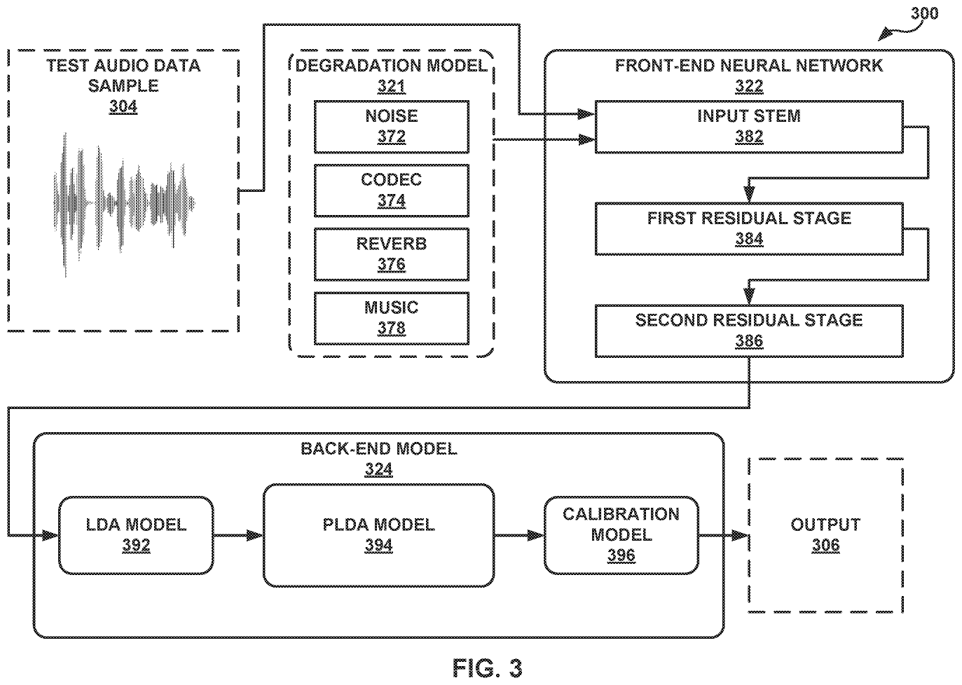

FIG. 3 is a conceptual diagram illustrating a system 300 for processing a test audio data sample 304 to generate an output 306, in accordance with one or more techniques of this disclosure. As seen in FIG. 3, system 300 includes test audio data sample 304, output 306, degradation model 321, front-end neural network 322, and back-end model 324. Degradation model 321 includes noise 372, codec 374, reverb 376, and music 378. Front-end neural network 322 includes input stem 382, first residual stage 384, and second residual stage 386. Back-end model 324 includes LDA model 392, PLDA model 394, and calibration model 396. In some examples, test audio data sample 304 may be an example of test audio data sample 104 of FIG. 1. In some examples, output 306 may be an example of output 106 of FIG. 1. In some examples, front-end neural network 322 may be an example of front-end neural network 122 of FIG. 1 or 222 of FIG. 2. In some examples, back-end model 324 may be an example of back-end model 124 of FIG. 1 or 224 of FIG. 2.

Text-to-speech models may generate realistic and human-like voices based on text input. As synthetic speech technology improves, this may increase an opportunity for malpractice in speaker identification (SID) via spoofing, the process of impersonating a human voice. When large volumes of speech samples are available online, malevolent actors may use this data to generate more realistic voice models. This is especially a problem for high-profile subjects such as politicians and celebrities who have vast amounts of multimedia available online.

Some systems for detecting synthetic speech rely on signal processing techniques that focus on acoustic features and train deep learning models to detect when an audio file has been manipulated through the characterization of unnatural changes or artifacts. In some cases, these techniques do not train a model using audio data including speech from the particular human speaker the model is designed to evaluate. One or more techniques described herein include using audio data from a speaker of interest to train a model for detecting deepfakes generated to imitate the speaker of interest. This may help to avoid spoofing attacks that target particular individuals. In some examples, the system may use audio data corresponding well-known people to adapt a speaker-specific spoofing detector to identify deepfakes more accurately than speaker-independent models.

The system described herein (e.g., systems 100, 200, and 300) may implement a front-end residual neural network trained to identify whether audio data includes synthetic speech or genuine speech and a back-end model (e.g., an LDA model and a PLDA model) trained to determine whether audio data includes genuine speech from a particular human. In some examples, the system described herein may identify deepfakes more accurately as compared with current systems for identifying speakers and current systems for identifying genuine and synthetic speech. In some examples, using even a small amount audio data from the speaker of interest to train and/or adapt the model improves a performance of the system as compared with systems that do not use subject-specific audio data to train and/or adapt the model.

Synthetic may undermine a status of multimedia documents as evidence of past situations. Synthetic speech generated by deep-fake algorithms can be used, in some cases, to falsify events, spread online misinformation, and perpetrate frauds. The quality of text-to speech (TTS) technology has improved due to the wide availability of data used to adapt deepfake models. Several end-to-end models such as WaveNet, Tacatron 1/2, Deep Voice 3, Fast-Speech 1/2, ClariNet, and EATS have improved the TTS technologies considerably in their ability to generate natural and intelligible speech. Consequently, the amount of deepfake content has consistently increased in recent years.

Training a high-quality TTS system that mimics a specific speaker may involve a large amount of transcribed speech from the speaker of interest. This means that high-profile individuals such as celebrities and politicians may be targets of malicious deepfake attacks perpetrated using TTS technologies. Some systems also leverage data from other speakers to improve the quality of the deepfake of the speaker of interest.

Due to recent developments in TTS, it may be beneficial to use individual speaker data to adapt a deepfake detection model. Some deepfake detection models may use signal processing techniques and deep learning methods to detect artifacts in an audio signal to determine whether the audio signal includes genuine or synthetic speech. Although some of these artifacts exhibit similar uncommon energy distributions, unnatural prosody, or high frequencies, deepfake generation models may mask these artifacts by adding background noise, adding music, applying filters to the signal, or using specific codecs. TTS technologies may be configured to reduce a level of artifacts if enough data is available to train the deepfake generation model properly. This means that deepfake detection models that rely on detecting artifacts might not be reliable for detecting high-performance synthetic speech. Furthermore, deepfake detection models that are not trained using audio data from the speaker of interest might not be reliable for detecting deepfakes specially targeted at the speaker of interest. System 300 may implement techniques for training a front-end neural network 322 using general training data to determine whether test audio data sample 304 includes genuine speech or synthetic speech. System 300 may implement techniques for adapt a back-end model 324 using individual speaker data to determine whether test audio data sample 304 includes speech from a particular human speaker. This means that System 300 may be configured to detect a deepfake targeted at a particular human being more reliably as compared with systems that rely on detecting artifacts without adapting a model based on individual speaker data.

One or more techniques may implement a deepfake detection approach that leverages the audio data from the speaker of interest (e.g., a particular human speaker) to differentiate between genuine and synthetic speech. The system 300 may adapt a back-end model 342 using audio samples featuring genuine speech from the speaker of interest so that the backend model is configured to compare genuine speech with a test audio data sample, re-calibrate the system output for a specific speaker of interest, and output a likelihood that the test audio data sample includes genuine speech from the speaker of interest and a likelihood that the test audio data sample includes synthetic speech generated to imitate speech from the speaker of interest. The system 300 may train a front-end neural network 322 (e.g., a residual neural network) to determine whether the test audio data sample includes genuine or synthetic speech. The system may adapt back-end model 324 to extract embeddings that used in PLDA model 394. In some examples, system 300 includes a front-end neural network 322 that is trained using training data that does not contain particular human speaker samples, and a back-end model 432 that is adapted using particular human speaker samples. In some examples, front-end neural network 322 includes acoustic features, a speech activity detector (SAD), and a deep-fake embedding extractor.

In some examples, front-end neural network 322 implements Linear Frequency Cepstral Coefficients (LFCC). LFCC may represent an acoustic feature that uses a series of filter banks on a linear frequency scale having uniform separation between filters. LFCC may provide higher signal resolution at high frequencies as compared with filter banks based on the Mel-scale because the separation between filters does not increase with frequency. These high frequencies may be beneficial for detecting deepfakes because artifacts in the synthetic speech are usually located in the limits of low and high frequencies of the speech spectrum.

Front-end neural network 322 may, in some examples, implement speech activity detection (SAD). In some examples, SAD may involve a deep neural network (DNN) with two hidden layers including 500 and 100 nodes, respectively. A SAD DNN may be trained using 20-dimensional Mel-frequency cepstral coefficients (MFCC) features, stacked with 31 frames. Before training a SAD DNN, features may be mean and variance normalized over a window including 201 frames. In some examples, using a low SAD threshold during training benefits the embeddings extractor as compared with using a high SAD threshold, while maintaining a strict threshold during evaluation necessary.

Front-end neural network 322 may, in some examples, include one or more deep residual networks (ResNets) configured to address neural network degradation and generalization. One or more skip connections in residual neural networks may address the degradation problem, and the residual neural network architecture has demonstrated impressive generalization for image recognition. In some examples, front-end neural network 322 may include a variation of a residual neural network trained to classify genuine human speech as opposed to synthetic speech. The residual neural network architecture may include a small modification in a down sampling block to use more information that is typically discarded in other residual neural network models. To improve DNN generalization, system 300 may, in some examples, use a one-class feature learning approach to train a deep embedding space of front-end neural network 322 with genuine speech samples. This may prevent the model from over-fitting to known synthetic speech classes. In some examples, the following equation may be used to train front-end neural network 322.

$${L}_{OC} = \frac{1}{N} {\sum }_{i = 1}^{N} log ( 1 + {e}^{α ( {m}_{{y}_{t}} - ) {( - 1 )}^{y} i} ) \qquad ( eq . 1 )$$

In some examples, [symbol] ∈ [symbol] ^{D} and [symbol] ∈ [symbol] ^{D} represent the normalized target class embeddings and weight vectors, respectively. In some examples, yᵢ∈0, 1 denotes sample labels, and m₀, m₁∈[−1, 1], m₀>m₁ represent angular margins between classes.

As used herein, the term “embedding” may refer to a vector representation of an audio sample. When audio samples are represented by vector embeddings, it may be possible to identify similarities and/or differences between audio samples that would not be possible without representing audio samples as one or more embeddings. For example, to train front-end neural network 322, processing circuitry of system 300 may transform each genuine audio data sample of a set of genuine audio data samples into one or more embeddings. Additionally, or alternatively, processing circuitry of system 300 may transform each synthetic audio data sample of a set of synthetic audio data samples into one or more embeddings. Embeddings corresponding to genuine audio data samples may possess one or more similarities with each other, and embeddings corresponding to synthetic audio data samples may possess one or more similarities with each other. There may be one or more differences between embeddings corresponding to genuine audio data samples and embeddings corresponding to synthetic audio data samples. These similarities and differences between embeddings may also be referred to herein as “patterns.”

An audio sample (e.g., test audio data sample 304 and/or one or more training data audio samples) may, in some examples, be converted into one or more acoustic features (e.g., LFCC). The one or more acoustic features may correspond to a vector output having a number output rate (e.g., 20 numbers for every 10 milliseconds (ms) of audio data). Front-end neural network 322 may process these numbers to extract one or more embeddings, where each embedding of the one or more embeddings corresponds to a window of time within the audio sample. In some examples, a 40 second audio data sample may include nineteen 4-second windows of data that are block-shifted every two seconds. Front-end neural network 322 may extract, for each time window, an embedding comprising a vector including a set of numbers.

In some examples, front-end neural network 322 includes an input stem, four residual stages, and an output layer. For example, front-end neural network 322 may include an input stem 382, a first residual stage 384, and a second residual stage 386. First residual stage 384 and second residual stage 386 may include the four residual stages and the output layer. Input stem 382 may include three 3×3 convolution layers. In some examples, the first convolution layer of input stem 382 may use stride 2 for down sampling, the first two convolution layers of input stem 382 may include 32 filters, and the last convolution layer of input stem 382 includes 64 filters.

In some examples, each of the first residual stage 384 and the second residual stage 386 includes one or more residual blocks, where each residual block consists of a residual path and an identity path. In some examples, the first residual stage 384 does not include down sampling blocks. In some examples, the second residual stage 386 includes a down sampling residual block in place of a residual block. An identity path of this down sampling block may, in some examples, first down sample with a 2×2 average pool for anti-aliasing. In some examples, a 1×1 convolution is used after down sampling to increase the number of feature maps, matching the residual path output. The first convolution block in the residual path may down sample with a stride of 2×2. The first convolution block may also double a number of feature maps to keep computation constant. To extract embeddings from front-end neural network 322, front-end neural network 322 may compute the mean of a last layer of the front-end neural network 322 before the output in windows of 2.5 seconds and 0.5 second steps.

To extract a set of embeddings, front-end neural network 324 may select the set of embeddings based on one or more characteristics of test audio data sample 304. For example, front-end neural network 324 may generate one or more vectors corresponding to discrete variables of test audio data sample 304, and extract the set of embeddings based on similarities and/or differences between the one or more vectors corresponding to discrete variables of test audio data sample 304 and the set of embeddings. Since the set of general training data used to train front-end neural network 322 includes a set of audio data samples known to be genuine and a set of audio data samples known to be synthetic, the set of embeddings extracted based on test audio data sample 304 may exhibit one or more patterns associated with genuine audio data samples and/or one or more patterns associated synthetic audio data samples.

In some examples, back-end model 324 may include an LDA model 392, a PLDA model 394, and a calibration model 396. In Back-end model 324 may use PLDA to perform speaker verification with embeddings. Back-end model 324 may apply PLDA to have a reference result of PLDA in embeddings for deep-fake detection. After extracting the embeddings from the front-end neural network 322, back-end model 324 may transform embeddings using LDA model 392. Back-end model 324 may perform mean normalizing variance normalizing, and/or L2 length normalizing. In some examples, back-end model 324 learn LDA, mean, and variance statistics from a back-end training dataset. PLDA model 394 may obtain scores for each pair of examples. PLDA model 394 may use a binary detector to determine if test audio data sample 304 includes genuine speech or synthetic speech using a trial. The trial may include genuine speech of the speaker of interest, and test speech than include either genuine or synthetic speech. The PLDA model 394 may use the following equation.

$${y}_{i} = μ + {U}_{1} \cdot {x}_{i} + {ϵ}_{i} \qquad ( eq . 2 )$$

In some examples, μ is the speaker-independent mean vector, U₁ is the eigenspeaker matrix, xᵢ is the speaker factor, and e models the residual variability.

In some examples, calibration model 396 may apply a discriminatively trained affine transformation from scores to log-likelihood ratios (LLRs). The parameters of this transformation may be trained to mitigate a weighted binary cross-entropy objective which measures an ability of the calibrated scores to make cost-effective Bayes decisions when they are interpreted as LLRs. When evaluation conditions differ from those in the calibration training data, this may negatively affect an average performance hard decisions made with the system. Calibration model 396 may use a regularization approach to adapt a global calibration model using individual speaker data. Calibration parameter training may use both positive and negative trial scores and use the speech of the speaker of interest to increase the score count of speaker of interest genuine trials to achieve a greater number of matched samples for this process as compared with systems that do not use individual speaker data.

System 300 may include a degradation model 321 that is configured to augment training data with one or more kinds of degradation. The one or more kinds of degradation may include noise 372, codec 374, reverb 376, and music 378. By augmenting training data with one or more kinds of degradation, the system may improve the front-end neural network 322 as compared with systems that do not augment training data. For example, augmenting the training data may improve an ability of front-end neural network 322 to determine whether the test audio data sample 304 includes genuine or synthetic speech as compared with systems that do not augment training data with degradation.

System 300 may execute, based on the test audio data sample 304, the front-end neural network 322 to generate an output. In some examples, the output indicates a likelihood that the test audio data sample 304 represents genuine audio data corresponding to speech performed by a human speaker. During a training of front-end neural network 322, system 300 may configured input stem 382, first residual stage 384, and/or second residual stage 386 based on one or more patterns present in genuine training data and one or more patterns present in synthetic data. Consequently, when front-end neural network 322 is trained, input stem 382, first residual stage 384, and second residual stage 386 may process the test audio data sample 304 to generate an output that indicates a likelihood that test audio data sample 304 includes genuine speech from a human speaker. In some examples, the output indicates a likelihood that test audio data sample 304 includes synthetic speech generated by a model configured to produce deepfakes that imitate human speech. In some examples, the output from front-end neural network 322 indicates a likelihood that test audio data sample 304 includes genuine speech from any human speaker without indicating a likelihood that the test audio data sample 304 includes genuine speech from a specific human speaker. If the output from front-end neural network 322 indicates that it is not probable that test audio data sample 304 includes genuine speech from any human speaker, system 300 may determine that the test audio data sample 304 includes synthetic speech that is not from a particular human speaker. In some examples, when the output from front-end neural network 322 indicates that it is not probable that test audio data sample 304 includes genuine speech from any human speaker, system 300 may execute back-end model 324 to determine whether test audio data sample 304 includes genuine speech from a particular human speaker.

In some examples, system 200 may execute, based on the output from the front-end neural network 322, the back-end model 324 to determine a likelihood that the test audio data sample 304 represents speech performed by a particular human. System 300 may, in some examples, adapt back-end model 324 to detect deepfakes targeting particular human speakers. In some examples, high-profile individuals may be targets for deepfakes because a large amount of media data is available online that include genuine recordings of these individuals. Therefore, deepfake generation models may be trained using available data featuring genuine speech from a particular human speaker such that the model may generate convincing deepfakes imitating the particular human speaker. System 300 may adapt back-end model 324 using available data featuring genuine speech from the particular human speaker, so that back-end model 324 is configured to detect deepfakes targeting the particular human speaker that are adapted using data available online.

Back-end model 324 is configured to generate an output 306 that indicates a likelihood that test audio data sample 304 includes genuine speech from the particular human speaker. In some examples, back-end model 324 may output the likelihood that the test audio data sample 304 represents speech performed by the particular human speaker. In this way, system 300 may use a two-tiered process of first determining a likelihood that the test audio data sample 304 represents genuine speech from any human speaker, and second determining a likelihood that the test audio data sample 304 represents genuine speech from a particular human speaker.

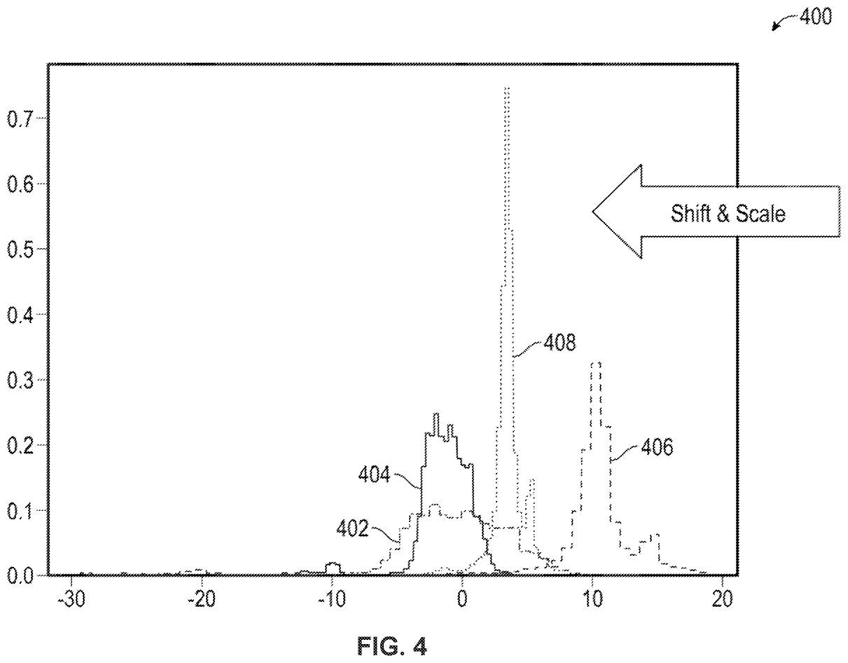

FIG. 4 is a conceptual diagram illustrating a graph 400 of one or more outputs from a system configured to determine a likelihood that a test audio data sample includes genuine speech from a particular human, in accordance with one or more techniques of this disclosure. As seen in FIG. 4, graph 400 includes a plot 402 of uncalibrated outputs corresponding to synthetic audio samples, a plot 404 of calibrated outputs corresponding to synthetic audio samples, a plot 406 of uncalibrated outputs corresponding to genuine audio samples, and a plot 408 of calibrated outputs corresponding to genuine audio samples. In some examples, calibration model 396 of FIG. 3 may calibrate outputs generated by back-end mode such that outputs corresponding to synthetic speech exhibit the distribution of plot 404 and outputs corresponding to synthetic speech from a particular human speaker exhibit the distribution of plot 408. In some examples, calibrating outputs from back-end model 324 may improve an ability of back-end model 324 to indicate whether a test audio data sample 304 includes genuine speech from a particular human being as compared with systems that do not calibrate outputs.

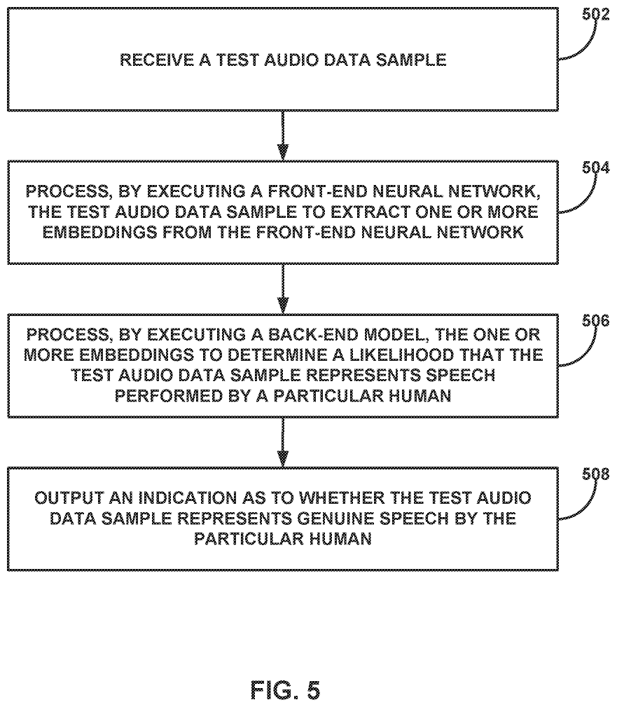

FIG. 5 is a flow diagram illustrating an example technique for determining a likelihood that a test audio data sample includes genuine speech from a particular human, in accordance with one or more techniques of this disclosure. FIG. 5 is described with respect to systems 100 and 200 of FIGS. 1-2. However, the techniques of FIG. 5 may be performed by different components of systems 100 and 200 or by additional or alternative systems.

Computing system 102 may receive test audio data sample 104 (502). In some examples, test audio data sample 104 may include synthetic speech generated to imitate a particular human. In some examples, test audio data sample 104 may include a recording of genuine speech that was actually spoken by a particular human speaker. In some examples, test audio data sample 104 may include one or more degradations such as noise, codec, reverb, or music.

In some examples, computing system 102 is configured to process, by executing a front-end neural network 122, the test audio sample 104 to extract one or more embeddings from the front-end neural network 122 (504). In some examples, front-end neural network 122 may be trained using general training data including a set of audio data samples known to include synthetic speech and a set of audio data samples known to include genuine speech from a human speaker. Computing system 102 may, in some examples, process, by executing a back-end model 124, the one or more embeddings to determine a likelihood that the test audio data sample 104 represents speech performed by a particular human (506). In some examples, back-end model 124 may be adapted using individual data including a set of audio data samples known to include genuine speech from the particular human. Computing system 102 may output an indication as to whether the test audio data sample represents genuine speech by the particular human (508).

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A computing system comprising:
a storage device configured to store a front-end neural network and a back-end model; and
processing circuitry having access to the storage device and configured to:
receive a test audio data sample;
process, by executing the front-end neural network, the test audio data sample to extract one or more embeddings from the front-end neural network;
process, by executing the back-end model, the one or more embeddings to determine a likelihood that indicates whether the test audio data sample represents speech by a particular human; and
output an indication as to whether the test audio data sample represents genuine speech by the particular human.

2. The computing system of claim 1, wherein the likelihood that that indicates whether the test audio data sample represents speech by the particular human comprises a likelihood that the speech corresponding to the test audio data sample is genuine speech.

3. The computing system of claim 1, wherein the output further indicates a likelihood that the test audio data represents synthetic audio data that is generated to imitate speech performed by the particular human.

4. The computing system of claim 1, wherein the storage device is further configured to store general training data comprising a set of genuine audio data samples and a set of synthetic audio data samples, and wherein the processing circuitry is configured to:
train the front-end neural network based on the set of genuine audio data samples and the set of synthetic audio data samples.

5. The computing system of claim 1, wherein the storage device is further configured to store general training data comprising a set of genuine audio data samples and a set of synthetic audio data samples, and wherein the processing circuitry is further configured to:
identify, based on the general training data, a set of patterns corresponding to the set of genuine audio data samples;
identify, based on the general training data, a set of patterns corresponding to the set of synthetic audio data samples; and
train the front-end neural network by configuring the front-end neural network with the set of patterns corresponding to the set of genuine audio data samples and the set of patterns corresponding to the set of synthetic audio data samples.

6. The computing system of claim 5, wherein by executing the front-end neural network, the processing circuitry is configured to:
process the test audio data sample to extract the set of embeddings based on one or more patterns present in the test audio data sample, the set of patterns corresponding to the set of genuine audio data samples, and the set of patterns corresponding to the set of synthetic audio data samples.

7. The computing system of claim 1, wherein the storage device is further configured to store individual speaker data comprising a set of genuine audio data samples corresponding to the particular human, and wherein the processing circuitry is further configured to:
adapt the back-end model based on the set of genuine audio data samples corresponding to the particular human to enroll the particular human.

8. The computing system of claim 7, wherein the set of genuine audio data samples is a first set of genuine audio data samples, wherein the particular human is a particular human, wherein the individual speaker data comprises a second set of genuine audio data samples corresponding to a second particular human, and wherein the processing circuitry is further configured to:
adapt the back-end model based on the second set of genuine audio data samples corresponding to the second particular human to enroll the second particular human.

9. The computing system of claim 7, wherein to adapt the back-end model based on the set of genuine audio data samples corresponding to the particular human, the processing circuitry is configured to:
adapt a calibration model of the back-end model based on the set of genuine audio data samples corresponding to the particular human such that the calibration model is configured to calibrate an output of the back-end model to indicate the likelihood that the test audio data sample represents speech performed by a particular human.

10. The computing system of claim 1, wherein the back-end model comprises a linear discriminant analysis (LDA) model, a probabilistic LDA (PLDA) model, and a calibration model, wherein to process the one or more embeddings to determine the likelihood, the processing circuitry is configured to:
transform, by executing the LDA model, the one or more embeddings based on an LDA formula;
normalize the transformed one or more embeddings based on a mean of the transformed one or more embeddings and a variance of the transformed one or more embeddings;
determine, by executing the PLDA model according to a PLDA formula, two or more scores based on the transformed and normalized one or more embeddings;
calibrate, by executing the calibration model, the two or more scores; and
calculate, based on the calibrated two or more scores, the likelihood that the test audio data sample represents speech performed by a particular human.

11. The computing system of claim 1, wherein the front-end neural network comprises a deep neural network (DNN).

12. A method comprising:
receiving, by processing circuitry having access to a storage device, a test audio data sample, wherein the storage device is configured to store a front-end neural network and a back-end model;
processing, by executing the front-end neural network by the processing circuitry, the test audio data sample to extract one or more embeddings from the front-end neural network;
processing, by executing the back-end model by the processing circuitry, the one or more embeddings to determine a likelihood that indicates whether the test audio data sample represents speech by a particular human; and
outputting, by the processing circuitry, an indication as to whether the test audio data sample represents genuine speech by the particular human.

13. The method of claim 12, wherein the likelihood that that indicates whether the test audio data sample represents speech by the particular human comprises a likelihood that the speech corresponding to the test audio data sample is genuine speech.

14. The method of claim 12, wherein the output further indicates a likelihood that the test audio data represents synthetic audio data that is generated to imitate speech performed by the particular human.

15. The method of claim 12, wherein the storage device is further configured to store general training data comprising a set of genuine audio data samples and a set of synthetic audio data samples, and wherein the method further comprises:
training, by the processing circuitry, the front-end neural network based on the set of genuine audio data samples and the set of synthetic audio data samples.

16. The method of claim 12, wherein the storage device is further configured to store general training data comprising a set of genuine audio data samples and a set of synthetic audio data samples, and wherein the method further comprises:
identifying, by the processing circuitry based on the general training data, a set of patterns corresponding to the set of genuine audio data samples;
identifying, by the processing circuitry based on the general training data, a set of patterns corresponding to the set of synthetic audio data samples; and
training, by the processing circuitry, the front-end neural network by configuring the front-end neural network with the set of patterns corresponding to the set of genuine audio data samples and the set of patterns corresponding to the set of synthetic audio data samples.

17. The method of claim 16, wherein by executing the front-end neural network, the method further comprises:
processing, by the processing circuitry, the test audio data sample to extract the set of embeddings based on one or more patterns present in the test audio data sample, the set of patterns corresponding to the set of genuine audio data samples, and the set of patterns corresponding to the set of synthetic audio data samples.

18. The method of claim 12, wherein the storage device is further configured to store individual speaker data comprising a set of genuine audio data samples corresponding to the particular human, and wherein method further comprises:
adapting, by the processing circuitry, the back-end model based on the set of genuine audio data samples corresponding to the particular human to enroll the particular human.

19. The method of claim 12, wherein the back-end model comprises a linear discriminant analysis (LDA) model, a probabilistic LDA (PLDA) model, and a calibration model, wherein processing the one or more embeddings to determine the likelihood comprises:
transforming, by executing the LDA model, the one or more embeddings based on an LDA formula;
normalizing the transformed one or more embeddings based on a mean of the transformed one or more embeddings and a variance of the transformed one or more embeddings;
determining, by executing the PLDA model according to a PLDA formula, two or more scores based on the transformed and normalized one or more embeddings;
calibrating, by executing the calibration model, the two or more scores; and
calculating, based on the calibrated two or more scores, the likelihood that the test audio data sample represents speech performed by a particular human.

20. A computer-readable medium comprising instructions that, when executed by a processor, cause the processor to:
receive a test audio data sample, wherein the processor is in communication with a storage device is configured to store a front-end neural network and a back-end model;
process, by executing the front-end neural network, the test audio data sample to extract one or more embeddings from the front-end neural network;
process, by executing the back-end model, the one or more embeddings to determine a likelihood that indicates whether the test audio data sample represents speech by a particular human; and
output an indication as to whether the test audio data sample represents genuine speech by the particular human.
